(19) United States
(12) Patent Application Publication
(10) Pub. No.: US 2004/0198842 A1
(43) Pub. Date: Oct. 7, 2004

(54) Aqueous defoamer formulations

(76) Inventors: Marcus Bocker, Essen (DE); Michel Gippert, Essen (DE); Roland Sucker, Werne (DE)

Correspondence Address: FROMMER LAWRENCE & HAUG LLP, 745 Fifth Avenue, New York, NY, 10151, US

(21) Appl. No.: 10/816,028

(22) Filed: Apr. 1, 2004

(30) Foreign Application Priority Data
Apr. 3, 2003 (DE) 103 15 158.3

(51) Int. Cl. B01F 17/54

(52) U.S. Cl. 516/53

(57) ABSTRACT

The invention relates to aqueous defoamer emulsions comprising at least one active defoaming substance and. if desired, customary auxiliaries and additives, which are characterized in that for the purpose of improving their defoaming action they comprise organopolysiloxane compounds having a viscosity of ≧1·10⁶ mPas in the form of an aqueous emulsion.

### RELATED APPLICATIONS

This application claims priority to German application Serial No. 103 15 158.3, filed Apr. 3, 2003, herein incorporated by reference.

### BACKGROUND OF THE INVENTION

1. Field of the Invention

The invention relates to improved aqueous defoamer formulations comprising at least one defoaming compound and, if desired, customary auxiliaries and additives, which for the purpose of enhancing the defoaming action and increasing the stability on storage and application comprise aqueous emulsions of high-viscosity organopolysiloxane compounds of high molecular mass.

2. Description of the Related Art

Numerous industrial operations deploy surface-active substances in order to obtain certain effects.

For instance, aqueous cooling lubricants require a range of auxiliaries, such as emulsifiers for emulsifying the water-insoluble mineral oils and/or additives such as corrosion inhibitors, for example.

Similarly, aqueous coating materials and detergent formulations require a series of auxiliaries, such as emulsifiers for emulsifying the water-insoluble active substances or else additives for improving substrate wetting and solids dispersion, for example.

An unwanted side-effect of these surface-active substances, however, is that the air introduced in the course of preparation or application is stabilized in the form of foam.

In many other industrial operations too, however, particularly those which involve substances of biological origin, such as proteins, saponins in the sugar industry or in wood pulp digestion for the production of cellulose in the paper industry, foam occurs as a disruptive accompanying phenomenon.

In such cases it is necessary to add foam preventatives or defoamers, since in certain circumstances foaming may greatly hinder the entire operation or jeopardize it completely.

Suitable active defoamer substances include oils of a very wide variety of kinds, such as organopolysiloxanes, in the form for example of silicone oils or polyoxyalkylene-polysiloxane block copolymers, polyethers, vegetable or animal oils, paraffins or mineral oils. The oils may contain finely divided solids which reinforce the defoaming action. An example of one such suitable finely divided solid is highly dispersed silica obtained by pyrolysis or wet chemistry, which is available commercially as Aerosil or Sipemat, and may have been hydrophobicized by treatment with organosilicon compounds. Other suitable solids include metal soaps such as magnesium, aluminum, and calcium soaps, and also polyethylene waxes and amide waxes. These prior art defoamer formulations are more or less suitable for preventing foam development or destroying existing foam in any of a very wide variety of industrial processes and products. It has become apparent, however, that their initial defoaming action, and in particular the long-term action, in applications involving high mechanical stresses, such as in cooling lubricants, for example, is not always up to the heightened technical requirements and is therefore in need of improvement.

### OBJECTS OF THE INVENTION

It is an object of the present invention, therefore, to find suitable defoamer formulations which exhibit an improved defoaming action and which retain this effect over prolonged periods even on storage in cooling concentrates, for example.

This object forming the basis of the invention is surprisingly achieved by the use of aqueous emulsions of high-viscosity organopolysiloxane compounds of high molecular mass in aqueous defoamer emulsions comprising at least one active defoaming substance. This and other objections will become apparent from the following Description of the Invention.

### DESCRIPTION OF THE INVENTION

The present invention accordingly provides aqueous defoamer emulsions comprising at least one active defoaming substance and, if desired, customary auxiliaries and additives, which for the purpose of improving the defoaming action comprise organopolysiloxanes having a viscosity of ≧about 1·10⁶ mPas, preferably ≧about 2·10⁶ mPas, in the form of an aqueous O/W emulsion. The organopolysiloxane compounds which can be used in accordance with the invention are known in principle and may be represented by the general formula (I)

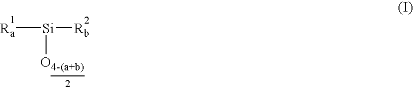

in which

R¹ is an alkyl radical, preferably having 1 to 4 carbon atoms, most preferably the methyl radical,

R² has the definition of R³, R⁴, R⁵, where

R³ identically or differently within the molecule can be branched or unbranched hydrocarbon radicals which may contain multiple bonds and may contain heteroatoms, and which have 5 to 26 carbon atoms,

R⁴ is one of the radicals —(CH₂)_{c}-(AO)_{d}—R⁷, where

A is an ethylene, propylene, i-propylene, butylene or styrene radical and

c is 2 or 3;

d is 1 to 100;

R⁷ can be H or R³, with the proviso that R⁴ constitutes not more than 10% of the radicals R²,

R⁵ can be one of the radicals R¹, —OH, —OC₁₋₄, aryl radical and styrene radical,

a can adopt any value from 1 to about 2, preferably 1.5 to 2, in particular 1.9 to 2,

b can adopt any value from 0 to 1, with the proviso that the viscosity of the compounds is ≧about 1·10⁶ mPas.

The skilled worker is aware that the compounds are in the form of a mixture having a distribution which is governed essentially by the laws of statistics.

Drawing on the systematics of organic polymers, it is possible in accordance with Noll to distinguish the following groups: mono-, di-, tri- or tetra-functional, for which the symbolized notations M, D, T and Q have been introduced:

[M]=(R¹, R²)₃SiO_{1/2}, [D]=(R¹, R²)₂SiO_{2/2},

[T]=(R¹, R²)SiO_{3/2}, and [Q]=SiO_{4/2}.

In accordance with the invention the structural types M, D, T, and Q can be used in the form of

(a) linear polysiloxanes [MDₙM];

(b) polysiloxanes with a low degree of branching through comblike polysiloxanes, containing trifunctional siloxane units [MₙDₘTₗ] as branching structural units.

(c) but preferably the crosslinked, rubber-elastic or elastomeric polymers in which the molecules are linked by means of T units to form two- or three-dimensional networks; and

(d) what are called MQ resins.

These compounds may additionally contain silicon-functional groups and/or organofunctional groups. Depending on chain length, degree of branching, and substituents they may be highly viscous, i.e., having viscosities ≧about 1·10⁶ mPas, or may be solid at room temperature.

In accordance with the invention it is preferred to use the crosslinked, rubber-elastic or elastomeric polymers (c) in which R³ radicals are alkyl radicals having 5 to 20 carbon atoms and in which up to 5% of the R³ alkyl radicals may have been replaced by OH groups.

The compounds used in accordance with the invention and their preparation are part of the known state of the art and in their low-viscosity versions are employed for a multiplicity of industrial applications, such as, for example, as emulsifiers in inks and paints, as an active substance and/or emulsifier in cosmetic skincare and haircare products, in abhesive coatings, and as defoamers (compare “Chemie und Technologie der Silicone”, Walter Noll, Verlag Chemie, 1960).

The compounds of the general formula (I) used in accordance with the invention, in the form of their aqueous emulsions, in which the mean particle size of the discontinuous phase is in the range between 0.1 to about 10 μm, preferably <5 μm, in particular <3 μm, are added to the commercially customary defoamer formulations. Emulsions having very high fractions of the compounds of the general formula (I), i.e., containing around 50% by weight of such compounds, are preferred since they do not unduly further dilute the end formulations. If desired or necessary, however it is also possible to prepare emulsions having lower active substance contents.

These emulsions can be prepared by the methods known from the prior art, as described in, for example, EP-A-0 771 629, EP-A-0 579 458, EP-A-0 463 431, U.S. Pat. No. 4,814,376, and U.S. Pat. No. 5,302,658, or in the further references cited therein. Preference in accordance with the invention is given to methods which allow particles in the range from about 0.1 to about 10 μm.

The improvement in the defoaming action of the aqueous emulsions of organopolysiloxane compounds in commercially customary defoamer emulsions comprising at least one active defoaming substance and, if desired, customary auxiliaries and additives, as used in accordance with the invention, is all the more surprising for the fact that these emulsions alone exhibit no defoaming action whatsoever (cf. table, emulsions 1 to 3 for CL concentrate, none added).

They can be used in all industrial processes where foam occurs as a disruptive side effect and in which aqueous defoamer formulations are used, particularly in high-foam processing operations in which substances of biological origin are processed, e.g., proteins, saponins, in the sugar industry or in wood pulp digestion for the production of cellulose in the paper industry, but also in the preparation and processing of polymer dispersions and in high-surfactant formulations such as, for example, in the textile industry, the printing inks industry, and in metalworking as, for example, cooling lubricants (CLs).

### EXAMPLES

The following non-limiting examples help illustrate the invention.

Emulsion 1:

50% O/W emulsion of a crosslinked siloxane of the general formula (I), in which R¹ is a methyl radical and R² is a C₁₆ hydrocarbon radical, a=1.98 and b=0.01, the silicone oil having a viscosity of ≧2·10⁶ mPas and a mean particle size distribution of 0.2 μm.

Emulsion 2:

50% O/W emulsion of a silicone oil, the silicone oil having a viscosity of 3·10⁶ mPas and a mean particle size distribution of 0.5 μm.

Emulsion 3:

50% O/W emulsion of a crosslinked siloxane of the general formula (1), in which R¹ is a methyl radical and R² is a C₈ hydrocarbon radical, a=1.95 and b=0.03, the silicone oil having a viscosity of >2·10⁶ mPas and a mean particle size distribution of 1.5 μm.

Defoamer 1:

Commercial antifoam concentrate based on an organically modified siloxane, which comprises hydrophobic organic solids and has been prepared in accordance with example 8 of DE-C-199 17 186.

Defoamer 2:

Commercial antifoam emulsion prepared in accordance with example 5 of EP-B-0 658 361.

Defoamer 3:

Tego® Antifoam KS 95 (commercial antifoam concentrate based on vegetable oils).

### Examples 1 to 9

2 parts of defoamer were mixed with one part of emulsion in accordance with the following matrix:

| | Defoamer 1 | Defoamer 2 | Defoamer 3 |
|---|---|---|---|
| Emulsion 1 | Example 1 | Example 2 | Example 3 |
| Emulsion 2 | Example 4 | Example 5 | Example 6 |
| Emulsion 3 | Example 7 | Example 8 | Example 9 |

Testing of the Defoaming Action:

50 g of cooling lubricant concentrate (A to C) are admixed with 0.025 g of the mixture under test. This concentrate is mixed thoroughly by stirring for 5 minutes. A ready-to-use cooling lubricant emulsion is then prepared in a 100 ml shaker cylinder, by diluting 3 g of the concentrate prepared beforehand with 47 g of demineralized water. The shaker cylinder is then shaken vigorously 30 times within 10 seconds. 1 minute after the end of shaking the height of the foam formed is read off.

Testing was carried out in the following commercially available cooling lubricant concentrates (CL):

Cooling Lubricant Concentrate A:

Water-miscible CL based on mineral oil, with a very high emulsifier content, from Oemeta.

Cooling Lubricant Concentrate B:

Water-miscible semisynthetic CL with 25% water content, from Castrol.

Cooling Lubricant Concentrate C:

Water-miscible CL based on mineral oil, from Houghton.

| | A | B | C | A | B | C |
|---|---|---|---|---|---|---|
| | Testing without storage of | | | Testing after storage of | | |
| | the concentrate beforehand | | | the concentrate for 4 weeks | | |
| CL concentrate | ml | ml | ml | ml | ml | ml |
| none added | >50 | >50 | >50 | >50 | >50 | >50 |
| Emulsion 1 | >50 | >50 | >50 | >50 | >50 | >50 |
| Emulsion 2 | >50 | >50 | >50 | >50 | >50 | >50 |
| Emulsion 3 | >50 | >50 | >50 | >50 | >50 | >50 |
| Defoamer 1 | >50 | 6 | 35 | >50 | 27 | >50 |
| Defoamer 2 | >50 | 0 | 25 | >50 | 8 | 46 |
| Defoamer 3 | >50 | 25 | >50 | >50 | >50 | >50 |
| Example 1 | 2 | 0 | 0 | 3 | 0 | 1 |
| Example 2 | 6 | 0 | 0 | 6 | 0 | 1 |
| Example 3 | 3 | 0 | 3 | 5 | 0 | 4 |
| Example 4 | 4 | 0 | 0 | 4 | 0 | 1 |
| Example 5 | 6 | 0 | 0 | 7 | 0 | 2 |
| Example 6 | 5 | 0 | 3 | 6 | 0 | 4 |
| Example 7 | 1 | 0 | 0 | 3 | 0 | 0 |
| Example 8 | 3 | 0 | 0 | 4 | 0 | 1 |
| Example 9 | 3 | 0 | 3 | 3 | 0 | 3 |

The above description of the invention is intended to be illustrative and not limiting. Various changes or modifications in the embodiments described herein may occur to those skilled in the art. These changes can be made without departing from the scope or spirit of the invention.

What is claimed is:

1. An aqueous defoamer emulsion comprising
A) at least one active defoaming substance and, optionally, at least one auxiliary or additive,
B) an oil-in-water emulsion consisting of at least one organopolysiloxane compound having a viscosity of ≧about 1·10⁶ mPas and water.

2. The aqueous defoamer emulsion as claimed in claim 1, wherein the mean particle size of the dispersed phase in the oil-in water emulsion B is in the range between about 0.1 μm to about 10 μm.

3. The aqueous defoamer emulsion as claimed in claim 1, wherein the oil-in-water emulsion comprises at least one organopolysiloxane compound of the formula (I) 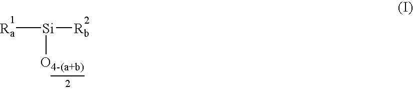
in which
R¹ is an alkyl radical,
R² has the definition of R³, R⁴, R⁵, where
R³ identically or differently within the molecule is a branched or unbranched hydrocarbon radical, which optionally contains multiple bonds and/or contains heteroatoms and which has at least 5 carbon atoms,
R⁴ is a radical —(CH₂)_{c}-(AO)_{d}—R⁷, where
A is an ethylene, propylene, i-propylene, butylene or styrene radical and
c is 2 or 3;
d is 1 to 100;
R⁷ is H or R³, with the proviso that R⁴ constitutes not more than 10% of the radicals R²,
R⁵ is a radical selected from the group consisting of R¹, —OH, —OC₁₋₄, aryl and styrene,
a is a value from 1 to about 2,
b is a value from 0 to 1,
with the proviso that the organosiloxane of the formula (I) has a viscosity that is ≧about 1·10⁶ mPas.

4. The aqueous defoamer emulsion as claimed in claim 1 comprises at least one organopolisiloxane compound of the formula: 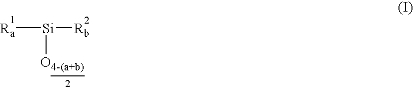
in which
R¹ is an alkyl radical having 1 to 4 carbon atoms,
R² has the definition of R³, R⁴, R⁵, where
R³ identically or differently within the molecule is a branched or unbranched hydrocarbon radical, which optionally contains multiple bonds and/or contains heteroatoms and which has 5 to 26 carbon atoms,
R⁴ is a radical —(CH₂)_{c}-(AO)_{d}—R⁷, where
A is an ethylene, propylene, i-propylene, butylene or styrene radical and
c is 2 or 3;
d is 1 to 100;
R⁷ is H or R³, with the proviso that R⁴ constitutes not more than 10% of the radicals R²,
R⁵ is a radical selected from the group consisting of R¹, —OH, —OC₁₋₄, aryl, and styrene,
a is a value from 1 to about 2,
b is a value from 0 to 1,
with the proviso that the organosiloxane has a viscosity that is ≧1·10⁶ mPas.

5. The aqueous defoaming emulsion as claimed in claim 4 wherein R¹ is methyl.

6. The aqueous defoamer emulsion as claimed in claim 1, wherein the organopolysiloxane in component B) is crosslinked, rubber-elastic or elastomeric polymer.

7. The aqueous defoamer emulsion as claimed in claim 1, wherein the oil-in-water emulsion comprises at least one organopolysiloxane compound of formula (I) in which the R³ radicals are alkyl radicals having 5 to 20 carbon atoms and in which up to 5% of the R³ alkyl radicals are optionally replaced by OH groups.

8. The aqueous defoamer emulsion as claimed in claim 1, wherein the oil-in-water emulsion comprises at least one organopolysiloxane compound of the formula (1) in which a is between 1.5 and about 2.

9. The aqueous defoamer emulsion as claimed in claim 1, wherein the oil-in-water emulsion comprises an organopolysiloxane compound of the formula (I) in which b is <0.5.

10. The aqueous defoamer emulsion according to claim 9, wherein b is <0.1.

11. A method for increasing the defoaming properties and/or storage properties of a defoamer formulation which comprises adding a compound of the formula: 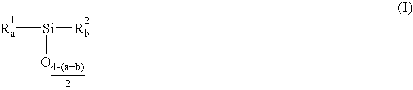
in which
R¹ is an alkyl radical having 1 to 4 carbon atoms,
R² has the definition of R³, R⁴, R⁵, where
R³ identically or differently within the molecule is a branched or unbranched hydrocarbon radical, which optionally contains multiple bonds and/or contains heteroatoms and which has 5 to 26 carbon atoms,
R⁴ is a radical —(CH₂)_{c}-(AO)_{d}—R⁷, where
A is an ethylene, propylene, i-propylene, butylene or styrene radical and
c is 2 or 3;
d is 1 to 100;
R⁷ is H or R³, with the proviso that R⁴ constitutes not more than 10% of the radicals R²,
R ⁵ is a radical selected from the group consisting of R¹, —OH, —OC₁₋₄, aryl, and styrene,
a is a value from 1 to about 2,
b is a value from 0 to 1,
with the proviso that the organosiloxane has a viscosity that is ≧1·10⁶ mPas to the defoamer emulsion.

12. The method according to claim 11, wherein the compound of formula (I) is present in approximately 50% aqueous concentrate, in which the mean particle size of the discontinuous phase is in the range between 0.1 μm and 10 μm.

13. An aqueous cooling lubricant which comprises the aqueous defoamer emulsion according to claim 1.

14. A polymer dispersion which comprises a polymer and the aqueous defoamer emulsion according to claim 1.

15. A printing ink which comprises a pigment and the aqueous defoamer emulsion according to claim 1.
